(19) United States
(12) Patent Application Publication
(10) Pub. No.: US 2010/0174569 A1
(43) Pub. Date: Jul. 8, 2010

(54) Destin

(76) Inventor: Wayne Beaubien, Coto De Caza, CA (US)

Correspondence Address: John Alumit, 16830 Ventura Blvd. Suite 360, Encino, CA, 91436, US

(21) Appl. No.: 12/319,111

(22) Filed: Jan. 2, 2009

(51) Int. Cl. G06Q 10/00; G06Q 50/00

(52) U.S. Cl. 705/6; 705/1.1; 705/7

(57) ABSTRACT

An enterprise resource planning (ERP) based total task integrated destination management system. The system is configured to operate in a Windows based platform comprising a destination management service organizer and a concierge service organizer for rendering hospitality services. The destination management service organizer is operable to receive a plurality of informational components such as an event category, destination of event, mode of travel, arrival and departure details, etc. from group travelers and/or Free Independent Travelers (FITs). The concierge service organizer is operable to receive a plurality of inputs from at least one customer for at least one program event such as, international conferences, ground logistics and hospitality programs, exhibitions, incentive travel programs, and corporate events. The system incorporates arrival and/or departure scheduling, transportation links and a database that includes interactive tables that may update automatically whenever a change is made to the informational components or the user inputs.

### CROSS-REFERENCE TO RELATED APPLICATION

Not Applicable

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The invention relates to travel-related services, and more particularly to an enterprise resource planning (ERP) based system and method for automated total task integrated destination access and management. The invention allows a user the ability to purchase multiple services for specific events in a destination.

With an increase in tourism around the world and demand for hospitality services associated with diverse industries, travelers opt for special itineraries and quick responses to their requisites. Also, developments in the corporate business sector have unveiled opportunities for corporate events, such as incentive travel programs, conferences and other hospitality programs. Generally, the management of these events includes proper planning, scheduling, organizing, and time execution.

Professional destination management companies (DMC) for corporate events manage the travel needs of groups and individuals, including hotel facilities, entertainment venues, transportation links and the like. Similarly, free independent travelers (FITs) constitute a major part of the tourism industry. These travelers prefer traveling alone rather than in a group. Rental cars or public transportation, rooms and other amenities need to be arranged and reserved in advance for these people at various destinations.

Several travel service management systems for facilitating travel needs have been developed in art. For example, U.S. Pat. No. 5,832,451 to Flake et al. on Nov. 3, 1998 discloses a method of automatically managing travel service information. The method generates a business entity profile and individual profile for customers, and stores the information in a relational database. Customer reservation information automatically accessed from plural computer databases is stored in the same database in a single format. Consequently, the customer reservation information and the profile are made available, simultaneously, for use by an agent in processing a customer's travel request.

U.S. Pat. No. 5,237,499 to Garback on Aug. 17, 1993 discloses a computer based system for processing travel requests from individual members of a sponsored group directed to a specific venue. The system comprises a database containing a venue file including information regarding the specific venue, a group member file for each individual member of the group, a travel policy file containing information on negotiated fares on pre-selected airlines, and a city code file containing codes corresponding to a plurality of city airport locations. Data is entered and information displayed to an individual group member making a travel request via a terminal, such as a personal computer. A central processing unit is in communication with the database and with a plurality of airline computerized reservation systems (CRS). The CPU is programmed to select an individual group member itinerary for the specific venue that includes specific airline flights, and if necessary, specific hotel accommodations and specific rental car services.

U.S. Pat. No. 5,634,016 to Steadham, Jr. et al. on May 27, 1997 provides a computer integrated event management system for use by hotels and entertainment producers in hotels that coordinates the entire process of event planning and implementation at a facility comprising a first digital signal processor that stores text information relating to the facility and events to be held at that facility, a second digital signal processor that is in communication with the first and produces and stores CAD drawings using the text information from the first digital signal processor, and a connecting means for translating changes to either processors whenever the text information or CAD drawings are altered. The system uses specialized software combined with a microcomputer network that includes a network file server, CAD/DATA station and DATA stations where facility personnel are able to efficiently plan and implement events. The system includes a fully relational database and a CAD module that are connected together using a third module such that, whenever a piece of information is changed in one place, it is automatically changed everywhere in the database. The connecting module permits the database and the CAD module to communicate by translating information from a database format into a graphic format readable by CAD software packages, as well as translating the graphic information back into the database format.

Although the above inventions serve a similar purpose, the object of the present invention is to provide an ERP based software that coordinates multiple destination management services that render services for corporate events or FITs. A further object of the present invention is to provide a concierge desk to automate numerous informational components like event category, mode of travel, exhibitions, etc. for travelers. Other objects of the present invention will become better understood with reference to the appended Summary, Description, and Claims.

### SUMMARY

The present invention is an Enterprise Resource Planning (ERP) based total task integrated destination management system. The system is configured to operate in a Windows based platform comprising a destination management service organizer and a concierge service organizer for rendering hospitality services.

The destination management service organizer is developed by way of software capable of understanding destination management semantics. The destination management service organizer is operable to receive a plurality of informational components such as an event category, destination of event, mode of travel, arrival and departure details or the like.

The concierge service organizer is operable to receive a plurality of inputs from at least one customer for at least one program event such as, but not limited to, international conferences, ground logistics and hospitality programs, exhibitions, incentive travel programs, and corporate events.

The destination management service organizer operates to analyze the requirements of group travelers and/or a free independent traveler (FIT). The destination management service organizer is designed to communicate between customers in an interactive way by means of communication media. The plurality of informational components received from customers is stored in a plurality of interactive tables associated with a system database. The tables are updated automatically whenever a change is made on user input.

The system utilizes a plurality of phases for rendering the services ordered by the group travelers and/or FIT. The service may be considered as an event project management program that can be accomplished through three phases: pre-event phase, an event phase, and a post-event phase. The phases include a proposal from the customer that may be changed to a contract for planning, organizing, and scheduling the specific program event in accordance with the activities offered to the customer. Subsequently, the billing and invoicing of the executed program event is performed.

The system also renders a plurality of concierge desk activities with a plurality of vouchers for the group of travelers and/or FIT. A system database includes a plurality of interactive tables linked together to receive a plurality of user inputs such as mode of travel, arrival and/or departure details, and the like. The system database is created in such a way to update automatically whenever at least one change is made to the user inputs. A guest itinerary is scheduled according to the user requirements

The customer can be provided with customized tariff of services that may be utilized to schedule events by selecting or editing an event from a list of standard programs that satisfies the need of the customer offered by means of proposals or contracts. The customer is also offered with a file note facility that permits the making of a record of operations of a program event and a reminder report for a specific program, a specific date, or a specific date range, etc. A user verifies orders, like purchase order or a need-to-order list, generated by the system according to a customer's requirements.

The system provides a passenger (PAX) list with enter and edit facility that includes transportation and room information to a customer for a program event and chronological flight arrival and/or departure details with an import manifest and program itinerary for calculating transportation link requirements. The billing and invoicing of the specific program event may be utilized to generate management reports such as program reports, financial reports, general reports and the like for accomplishing revenue forecasting.

Although particular embodiments of the present invention have been described in the foregoing description, it is to be understood that the present invention is not to be limited to just the embodiments disclosed, but that they are capable of numerous rearrangements, modifications and substitutions without departing from the description herein.

### BRIEF DESCRIPTION OF THE FIGURES

FIG. 1 is a top level diagrammatic perspective view of an ERP based total task integrated destination management system according to the present invention.

FIG. 2 is a schematic diagram illustrating different phases of operational events of the present invention.

FIG. 3 is a high level operational flow chart of a destination management service organizer of the present invention.

FIG. 4 is a high level operational flow chart of a concierge service organizer of the present invention.

FIG. 5 is a window or a webpage of the present invention, illustrating a customized tariff of services utilized to schedule events.

FIG. 6 is a window or a webpage of the present invention, illustrating a list of standard events and all supplies associated to that event allowing proposals or contracts to be created.

FIG. 7 is a window or a webpage allowing a customer to select or edit an event from a list of standard programs of the present invention.

FIG. 8 is a window or a webpage of the present invention, illustrating a list of all events of a scheduled program event and allowing a customer to edit program activities.

FIG. 9 is a window or a webpage designed to create and customize proposals and contracts according to the customer requirements of the present invention.

FIG. 10 is a window or webpage illustrating a file note facility that permits the making of a record of a plurality of operations of at least one program event of the present invention.

FIG. 11 is a window or webpage illustrating a reminder report for a specific program, a specific date, or a specific date range of the present invention.

FIG. 12 is a window or webpage of a purchase order for at least one program event of the present invention.

FIG. 13 is a window or webpage of a need-to-order list of at least one program event of the present invention.

FIG. 14 is a window or webpage that allows a user to verify orders according to a customer's requirements of the present invention.

FIG. 15 is a window or webpage that illustrates a PAX list with enter and edit facilities that includes a plurality of transportation information and room information to at least one customer for at least one program event of the present invention.

FIG. 16 is a window or webpage that illustrates chronological flight arrival details for calculating transportation link requirements of the present invention.

FIG. 17 is a window or webpage that illustrates chronological flight departure details for calculating transportation link requirements of the present invention.

FIG. 18 is a window or webpage that illustrates at least one import manifest of at least one program event of the present invention.

FIG. 19 is a window or webpage that illustrates a program itinerary for at least one program event of the present invention.

FIG. 20 is a window or webpage of the present invention, illustrating a daily overview report for at least one program event.

FIG. 21 is a window or webpage of the present invention, illustrating billing of a supplier invoice.

FIG. 22 is a window or webpage of a trial invoice of at least one program event of the present invention.

FIG. 23 is a window or webpage of the present invention, illustrating a 180 day financial report for revenue forecasting.

FIG. 24 is a window or webpage of the present invention, illustrating a program menu for generating a plurality of program reports.

FIG. 25 is a window or webpage of the present invention, illustrating a program menu for generating a plurality of financial reports.

FIG. 26 is a window or webpage of the present invention, illustrating a program menu for generating a plurality of general reports.

FIG. 27 is a window or webpage of the present invention, illustrating the e-DMC for creating an account to store various programs and details.

FIG. 28 is window or webpage of the present invention, illustrating the e-DMC program list creation option.

FIG. 29 is a window or webpage of the present invention, illustrating the e-DMC program list.

FIG. 30 is a window or webpage of the present invention, illustrating the e-DMC create program details.

FIG. 31 is a window or webpage of the present invention, illustrating the e-DMC import manifest option.

FIG. 32 is a window or webpage of the present invention, illustrating the e-DMC import manifest sample download.

FIG. 33 is a window or webpage of the present invention, illustrating the e-DMC import manifest sample data.

FIG. 34 is a window or webpage of the present invention, illustrating the e-DMC program list sample editing.

FIG. 35 is a window or webpage of the present invention, illustrating an e-DMC event selection sample list.

FIG. 36 is a window or webpage of the present invention, illustrating a particular e-DMC event selection.

FIG. 37 is a window or webpage of e-guestACCESS, illustrating a user interface that is designed specifically for the FIT market segment using the same DESTIN database of information.

### REFERENCE NUMERALS

10 . . . ERP based total task integrated destination management system

11 . . . Destination management service organizer

12 . . . Concierge service organizer

13 . . . Database

14, 15 . . . Customer

16 . . . Network

17 . . . User

20 . . . Different phases of operational events

21 . . . Event project management

22 . . . Pre-event

23 . . . Event

24 . . . Post-event

25 . . . Proposal

26 . . . Contract

27 . . . Planning

28 . . . Organizing

29 . . . Scheduling

30 . . . Execution

31 . . . Billing

32 . . . Invoicing

40 . . . High level flow chart of destination management service organizer

41 . . . Reception of informational components

42 . . . Proposal preparation

43 . . . Proposal to contract conversion

44 . . . Transportation scheduling

45 . . . Management report generation

46 . . . Invoice preparation

50 . . . High level flow chart of concierge service organizer

51 . . . Reception of inputs

52 . . . System database creation

53 . . . Voucher customization

54 . . . Guest itinerary tracking

55 . . . Concierge desk service monitoring

56 . . . Management report generation

57 . . . Invoice preparation

### DETAILED DESCRIPTION

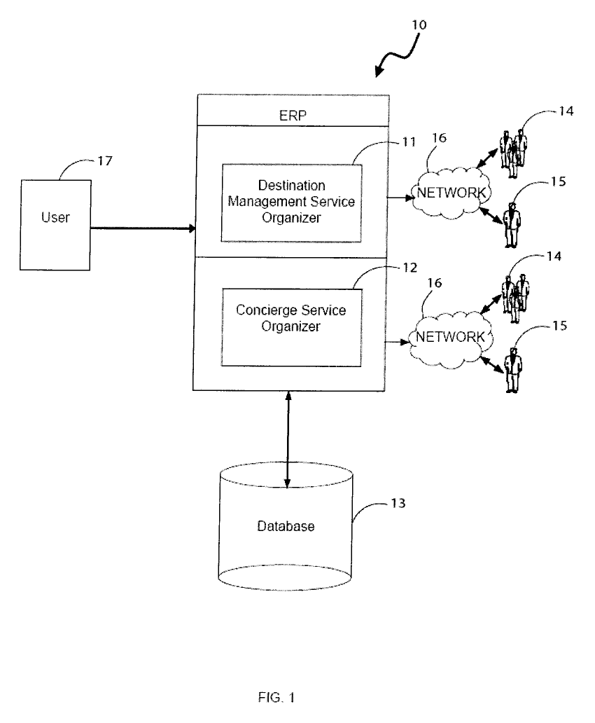

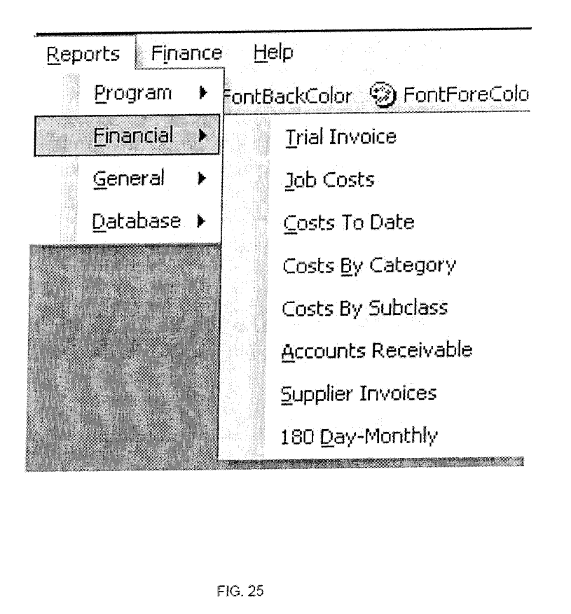

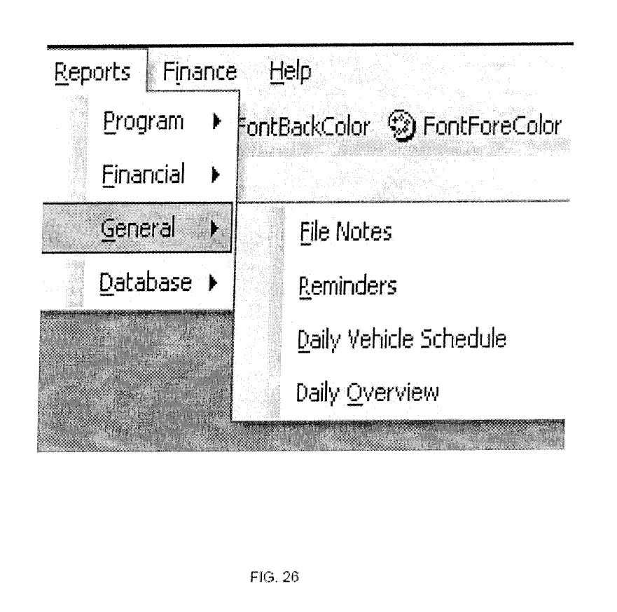

Referring to the drawings, the preferred embodiment of an ERP based total task integrated destination management system 10 is illustrated in FIGS.1 through 26. Referring to FIG. 1, the major components of the ERP based total task integrated destination management system 10 are illustrated. The system 10 is configured to operate in a Windows based platform comprising a destination management service organizer 11 and a concierge service organizer 12 for rendering hospitality services. The destination management service organizer 11 is developed by way of software capable of understanding a plurality of destination management semantics. The destination management service organizer 11 is operable to receive a plurality of informational components such as an event category, destination of event, mode of travel, arrival and departure details and the like. The concierge service organizer 12 is operable to receive a plurality of inputs from at least one group of customers 14 for at least one program event such as, but not limited to international conferences, ground logistics and hospitality programs, exhibitions, incentive travel programs, and corporate events.

The destination management service organizer 11 operates to analyze the requirements of a group of customers 14 such as group travelers and/or a free independent traveler (FIT) 15. The destination management service organizer 11 is designed to communicate between the customers 14, 15 in an interactive way by means of at least one communication media through a network 16. This allows the customers 14, 15 to order a plurality of services in a quick and easy-to-operate manner. The plurality of informational components received from the customers 14, 15 is stored in a plurality of interactive tables (not shown) associated with a system database 13. The tables (not shown) are designed to update automatically whenever at least one change is made on at least one user input.

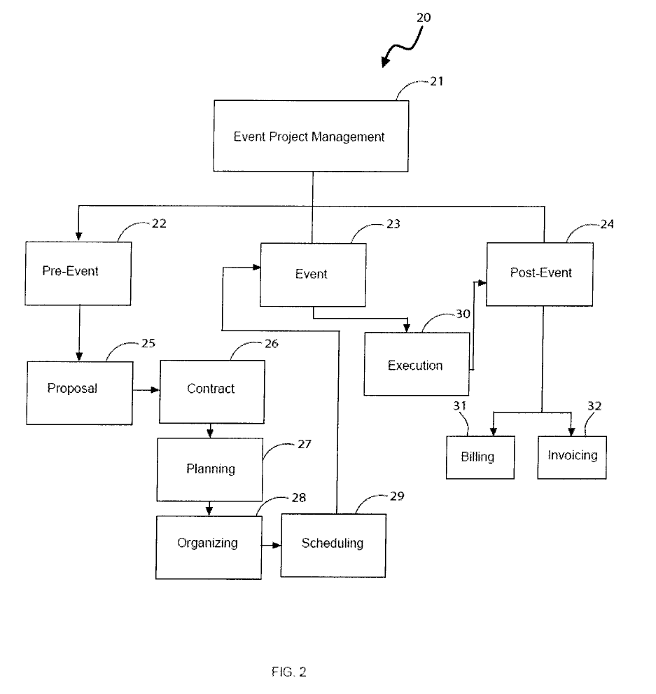

FIG. 2 illustrates a block diagram of different phases of a plurality of operational events generally indicated 20 that is associated with the total task integrated destination management system 10. The system 10 utilizes a plurality of phases for rendering at least one service ordered by the group of customers 14 such as group travelers and/or FIT 15. The service may be considered as an event project management program as indicated at block 21. The event project management 21 can be accomplished through three phases such as a pre-event phase 22, an event phase 23, and a post-event phase 24. The pre-event phase 22 further includes a plurality of sub task modules for accepting at least one proposal 25 from the customer 14, 15. Based on the review of the proposal 25 by the customer 14, 15, the proposal 25 may be changed to a contract 26. Subsequently, a module for planning 27, a module for organizing 28, and a module for scheduling 29 are designated to work in accordance with the activities offered to the customer 14, 15 through the contract as indicated at block 26. The event phase 23 includes the actual execution of the at least one program event such as a destination tour, a conference, exhibition or other corporate event as indicated at block 30. After the event phase 23, a post event module as indicated at block 24 is executed. The post event phase 24 further includes a module for billing 31 the at least one executed event and a module for invoicing 32 the at least one event.

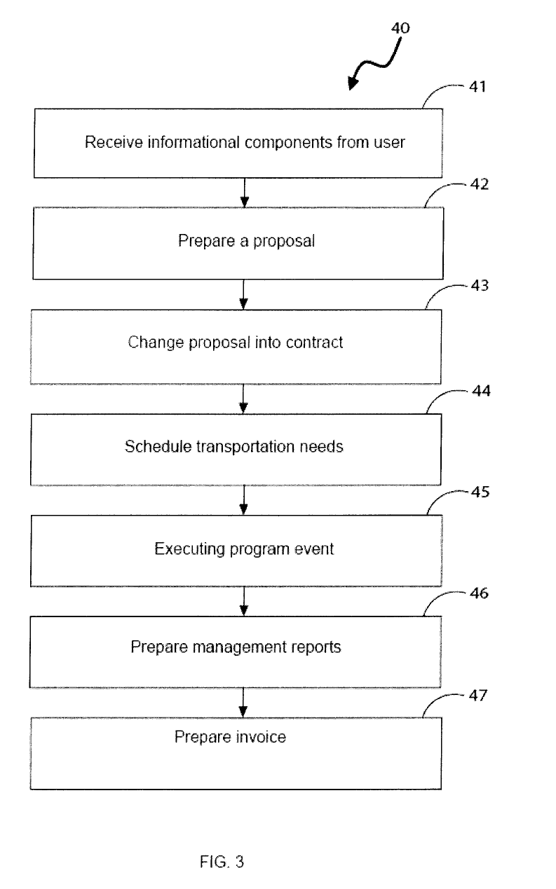

FIG. 3 is a high level flow chart 40 of a plurality of operational procedures involved in the destination management service organizer 11. A plurality of informational components such as an event category, destination of event, mode of travel, arrival and departure details and the like, is received from the at least one customer 14, 15 as indicated at block 41. According to the plurality of informational components received, a proposal being prepared for satisfying the customer needs as indicated at block 42. The proposal 25 can be sent to the customer 14, 15 for review thereby ensuring at least one program itinerary. The review by the customer 14, 15 may result in changing the proposal 25 to a contract 26 as indicated at block 43. The transportation needs for the customer 14, 15 are arranged according to the contract policies as indicated at block 44. The at least one specific program event 23 is then executed as indicated at block 45. Then, a plurality of management reports such as a 180 day report, a plurality of program and general reports, and the like, being prepared for revenue forecasting as indicated at block 46. Finally, after executing the at least one program event 23, a process for preparing billing and invoicing is performed accordingly as indicated at block 47.

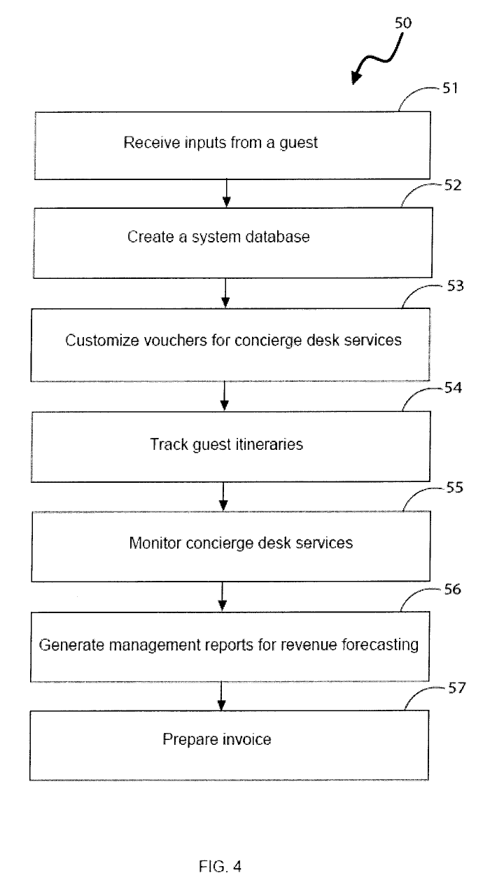

FIG. 4 is a high level operational flow chart 50 for rendering a plurality of concierge desk activities for the at least one guest such as a group of travelers 14 and/or FIT 15. The plurality of concierge desk activities can be initiated by receiving a plurality of inputs from the at least one guest 14, 15 as indicated at block 51. Based on the plurality of user inputs such as mode of travel, arrival and/or departure details and the like, a system database 13 is created as indicated at block 52. The system database 13 further includes a plurality of interactive tables (not shown) linked together to receive a plurality of user inputs. The system database 13 is created in such a way to update automatically whenever at least one change is made to the plurality of user inputs incorporated in the plurality of interactive tables (not shown). Next, a plurality of vouchers for the plurality of concierge desk services are customized as indicated at block 53. According to the user requirements, at least one guest itinerary is scheduled as indicated at block 54.

The plurality of concierge desk services, such as arranging a plurality of vehicles, hotel facilities, entertainment venues, transportation links and the like, may be monitored as indicated at block 55. A plurality of management reports of the plurality of concierge desk services may be generated for revenue forecasting as indicated at block 56. Finally, at least one invoice may be prepared for the plurality of rendered concierge desk services as indicated at block 57.

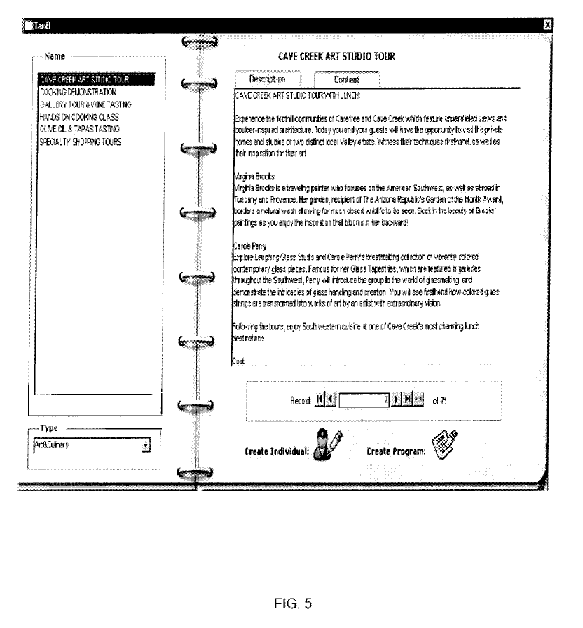

FIG. 5 is a window or webpage illustrating a customized tariff of services utilized to schedule a plurality of at least one program event. The customized tariff is a book of services, and each page contains a plurality of critical information that would facilitate the scheduling of an event. The window allows a user to navigate between a plurality of programs stored in the system database with the push of a button. In addition, the window facilitates the sorting of standard events by event category such as tours, museums, teambuilding and the like.

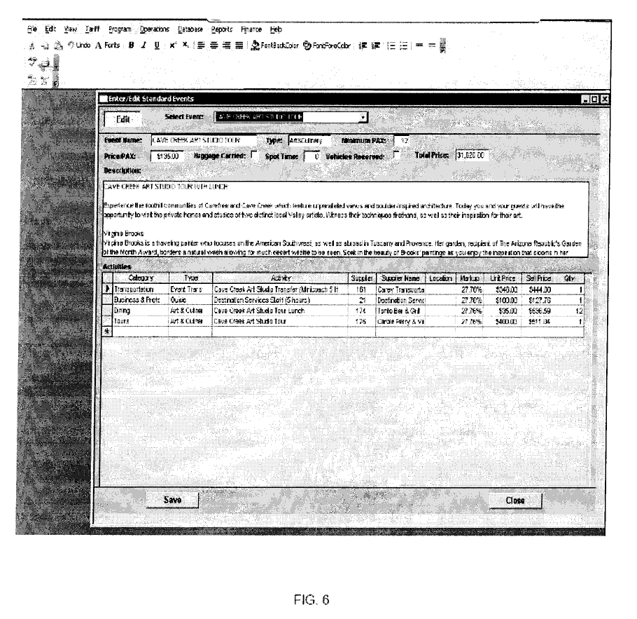

FIG. 6 is a window or webpage illustrating a list of standard events that contain all supplies associated with that event. The plurality of activities is provided in fully priced out manner. The window also allows the user to select at least one event from the list of events and displays the plurality of information associated with the selected event. Additionally, the window allows proposals or contracts to be created in a quick way. Other items that may be included in the window are event type, minimum PAX, price/PAX, baggage carried, spot time, vehicles reserved, total price, description of the event, and the like.

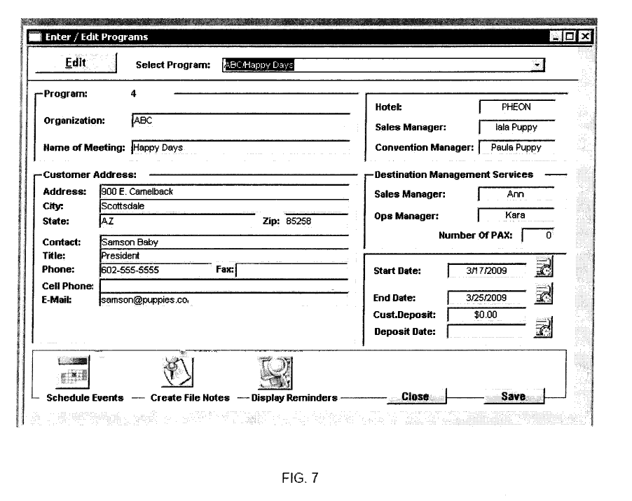

FIG. 7 is a window or webpage that allows the at least one customer to select or edit an event from a list of standard program events. The window may be utilized to keep records of a plurality of conversations by a single push of a button. The webpage further includes details pertaining to program, customer address, hotel, destination management services, dates, deposit etc.

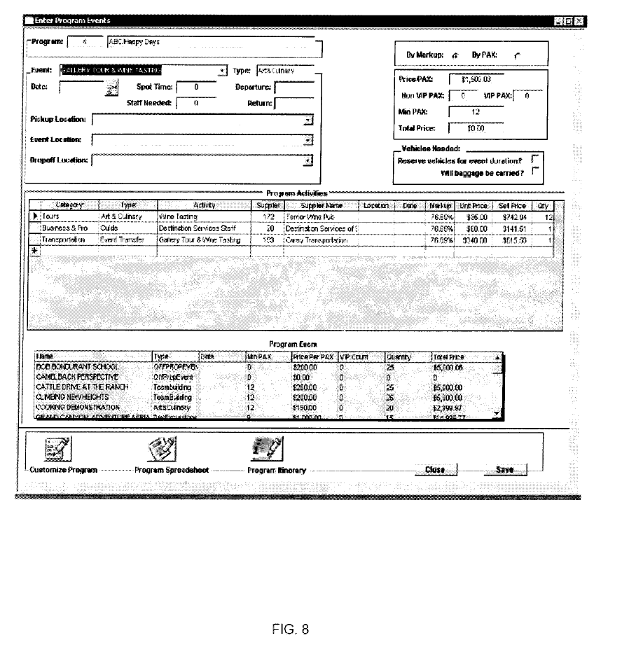

FIG. 8 is a window or webpage illustrating a list of all events of a scheduled program event and allowing a customer to edit a plurality of program activities. The window includes other details, such as a program number in the database, program name, vehicle information, such as pick up and drop off location, program activities, program events and the like. The window also includes navigation buttons for such things as customizing a program, a program spreadsheet, and a program itinerary.

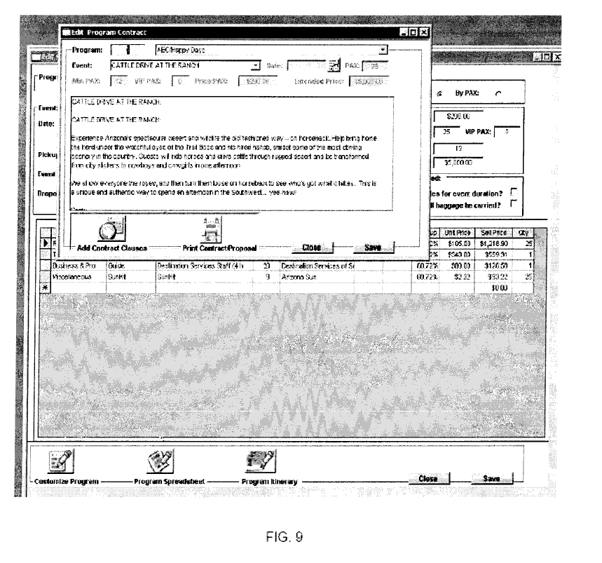

FIG. 9 is a window or webpage designed to create and customize proposals and contracts according to a customer's requirements. The event may be selected from the list of program events and may be customized to meet the customers need. The window allows the user to check the program spreadsheet to confirm the quoted pricing in order to satisfy the desired profit margin before the proposal is sent out. The window also allows the user to send the program itinerary to the customer with the proposal for review, and the customer can add proposals or contract clauses, thereby facilitating the completion of the proposal or contract.

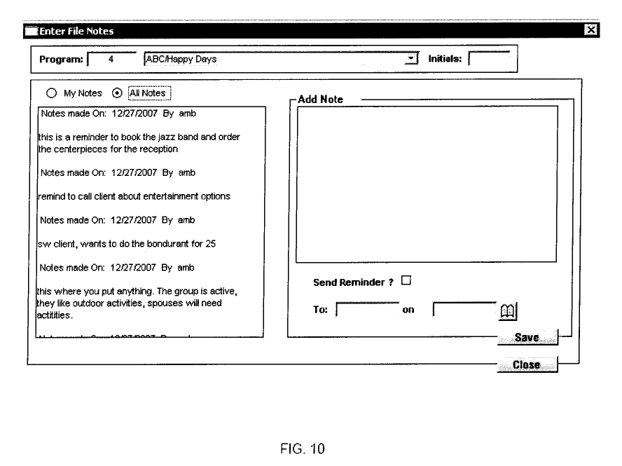

FIG. 10 is a window or webpage that illustrates a file note facility that permits the making of a record of a plurality of operations of the at least one program event. The add note facility in the webpage provides an area for keeping a record of conversations with the at least one customer and the at least one supplier, thereby triggering the user to take care of a specific aspect of the program. The window allows for displaying the history of file notes associated with the specific program.

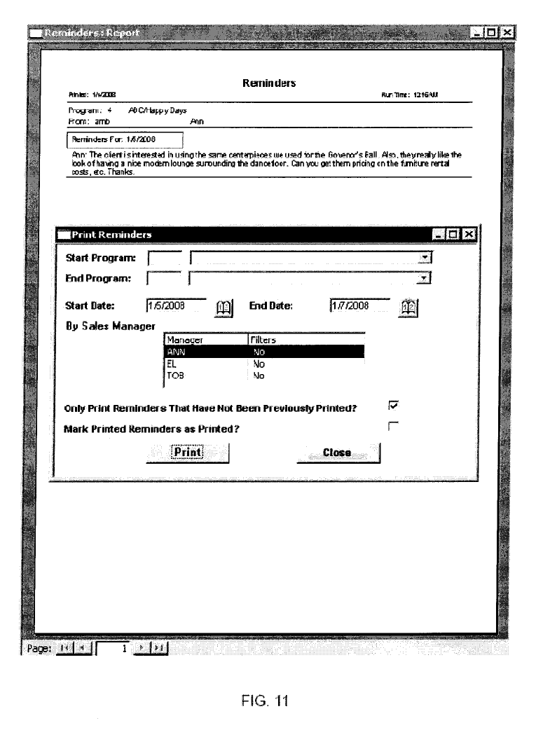

FIG. 11 is a window or webpage that illustrates a reminder report for a specific program, a specific date, or a specific date range. The print reminder facility associated with the window allows the user to print the reminders and to mark the reminders as printed. This feature permits a team to work together on a program thereby enabling them to respond to customer requisites and feedbacks in an effective way.

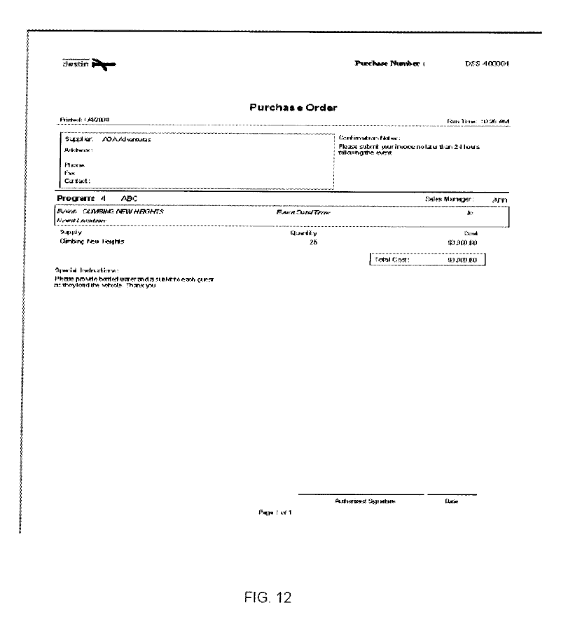

FIG. 12 is a window or webpage of a purchase order for at least one program event. The window permits the user to customize the numbering of purchase orders to meet accounting needs. The customizing may be easily achieved by way of a plurality of special instructions and confirmation notes.

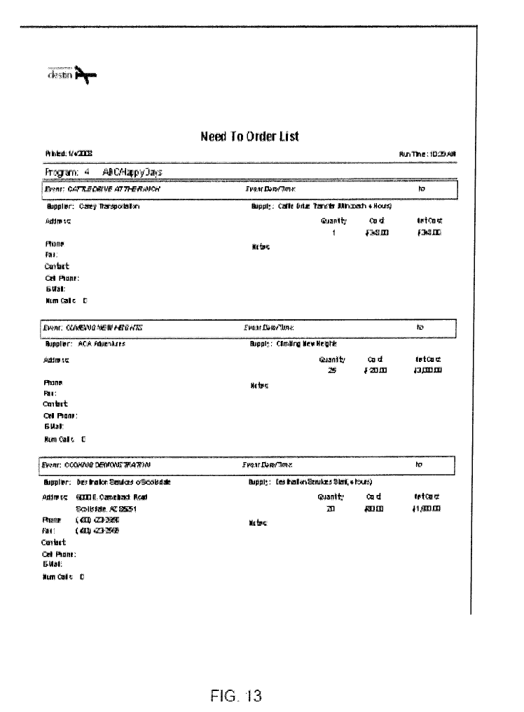

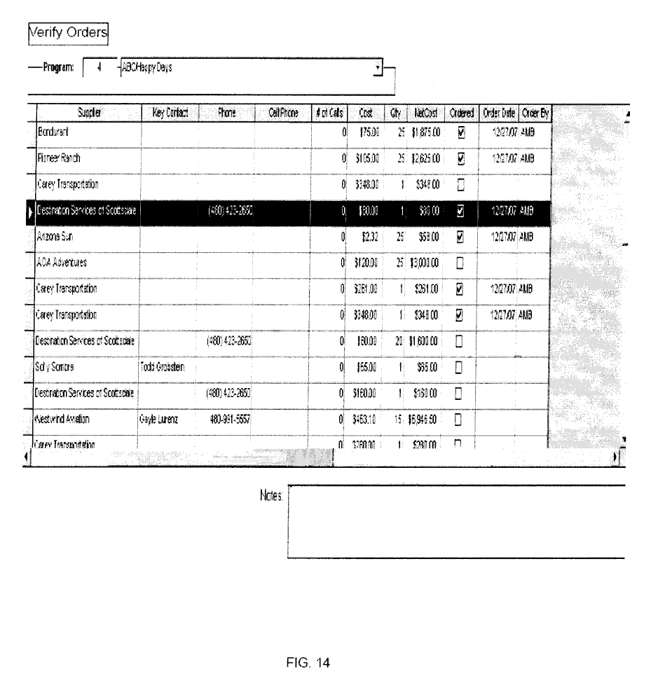

FIG. 13 is a window or webpage that illustrates a need-to-order list of the at least one program event. FIG. 14 is a window or webpage that allows a user to verify the orders according to a customer's requirements. The checklist allows the user to check off the plurality of services ordered for the at least one program. As the user checks off the plurality of services in the list, they are transferred from the need-to-order list to an “orders-to-date list”. These automated checks enable the timely delivery of a plurality of services to the customer.

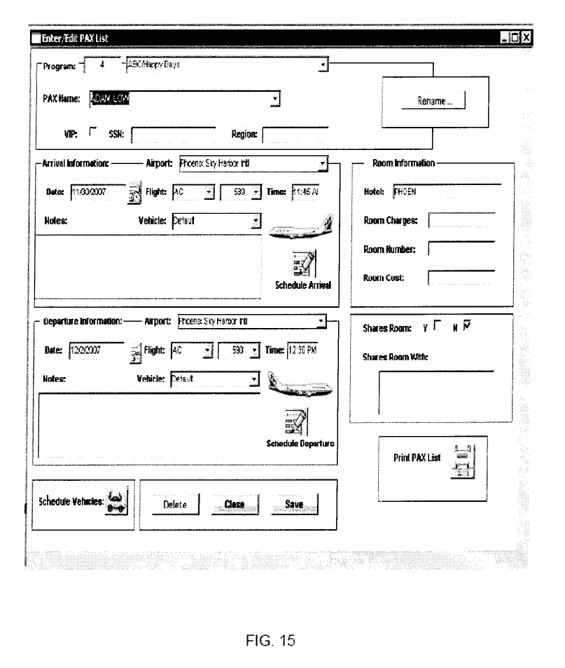

FIG. 15 is a window or webpage that illustrates a PAX list with enter and edit facilities that includes a plurality of transportation information and room information to the at least one customer for the at least one program event. The webpage displays a passenger list, identify VIP passengers, creates a plurality of notes for at least one transportation vendor, and schedules arrival and/or departure details and vehicles for the at least one customer.

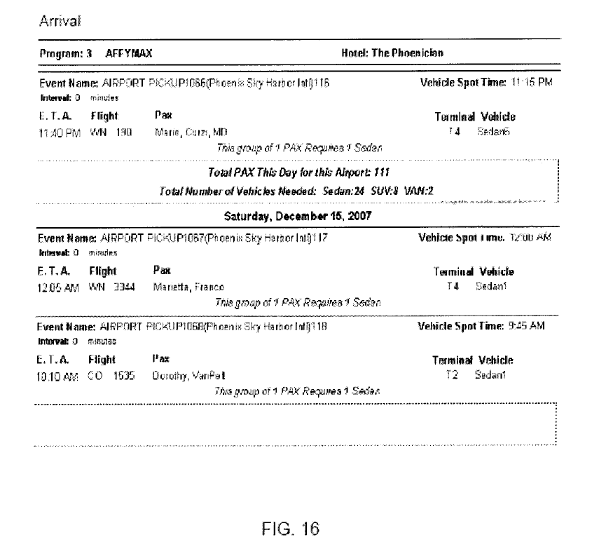

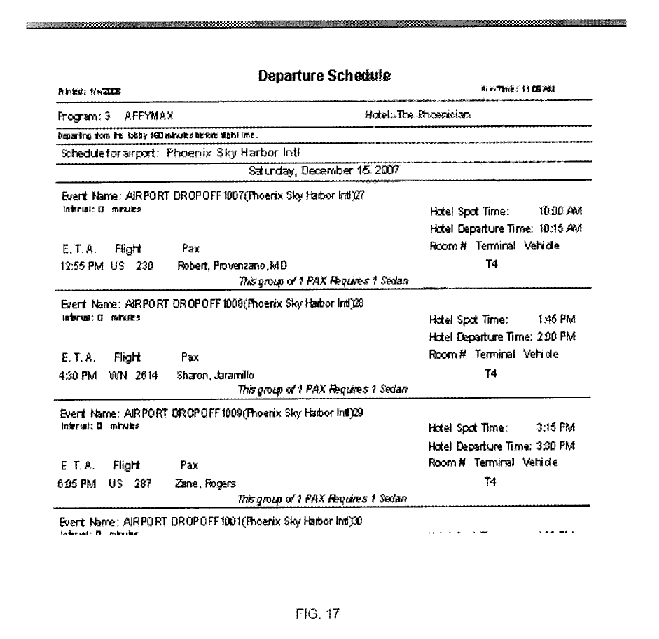

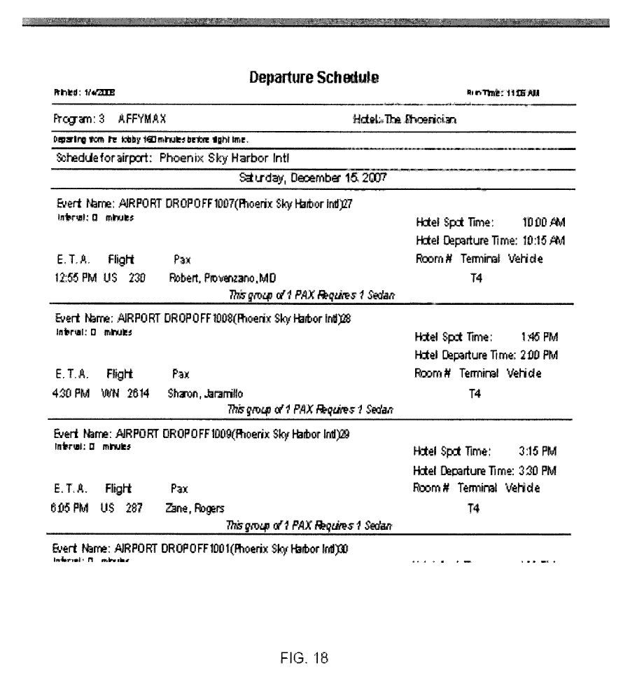

FIG. 16 is a window or webpage that illustrates chronological flight arrival details for calculating transportation link requirements. The webpage allows calculating the transportation needs in a chronological order. FIG. 17 is a window or webpage that illustrates chronological flight departure details for calculating transportation link requirements. The system calculates the time to get to the airport and automatically schedules the departure including the type of vehicle needed for the customer to travel. Similarly, FIG. 18 is a window or webpage that illustrates at least one import manifest of at least one program event. The import manifest is a customized excel template that renders flight arrivals and departure details that permits the at least one customer to import a plurality of names in less time.

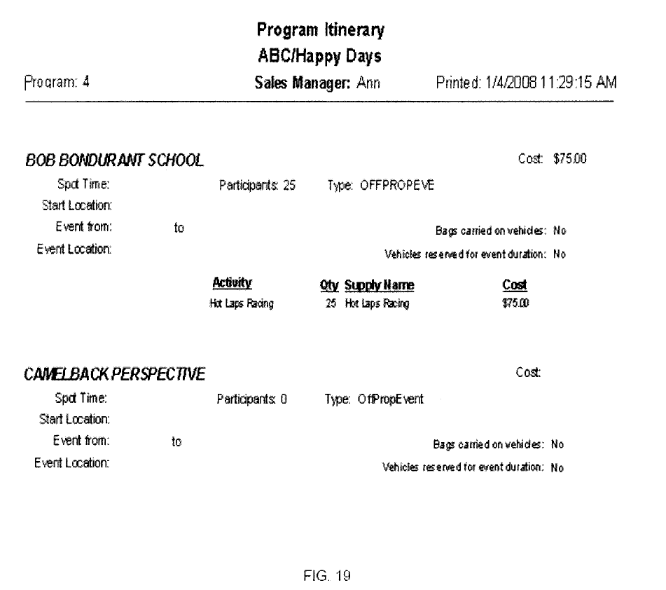

FIG. 19 is a window or webpage that illustrates a program itinerary for at least one program event. The window displays a plurality of operations of the at least one program event. Other items that can be rendered under the program itinerary webpage include at least one activity associated to the plurality of operations, number of participants, vehicle reservation details, and the like.

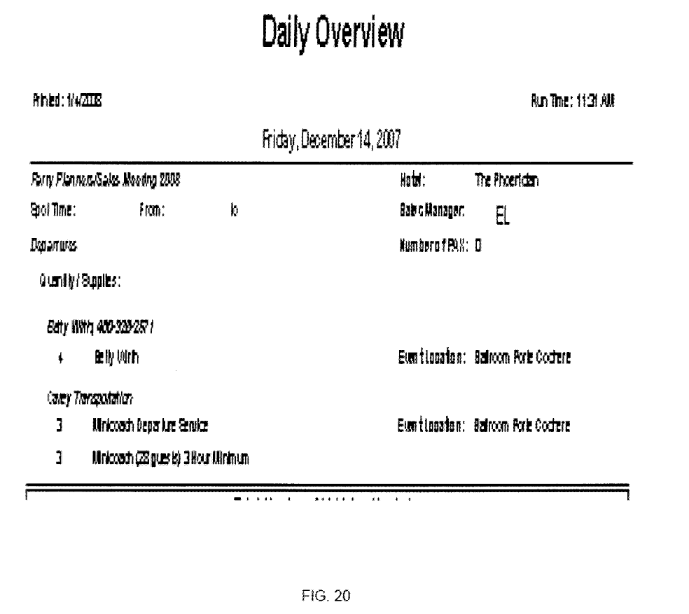

FIG. 20 is a window or webpage for illustrating a daily overview report for at least one program event.

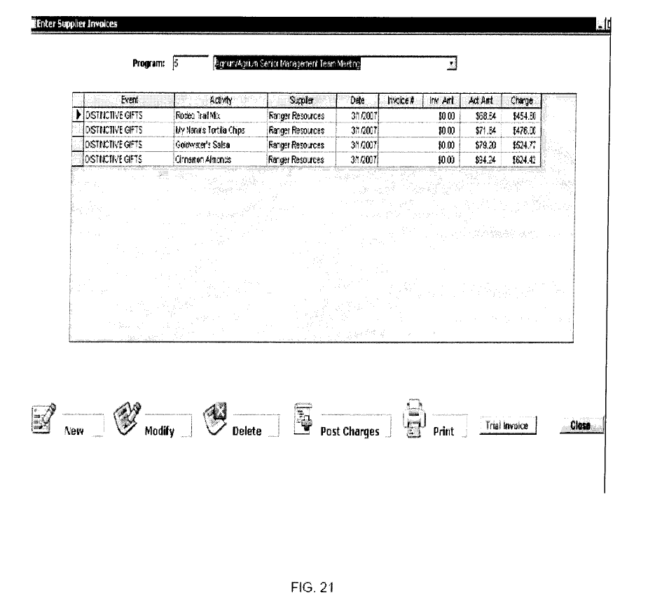

Referring to FIG. 21, a window or webpage for billing a supplier invoice is illustrated. The webpage allow the posting of all supplies ordered for the at least one program event thereby preparing a final billing. In addition, the webpage includes options for adding at least one new entry, modifying and/or deleting at least one entry, printing, posting charges, and preparing a trial invoice.

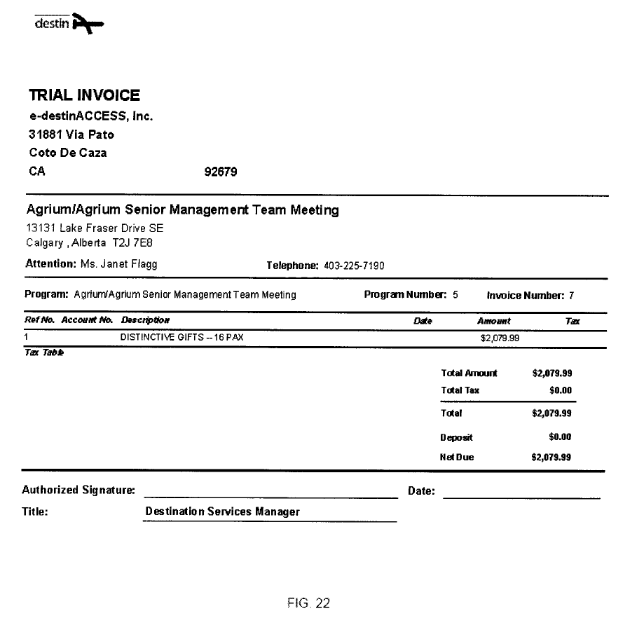

FIG. 22 is a window or webpage of a trial invoice of at least one program event. The window may be customized to add service charges and applicable taxes. Also the user may print the trial invoice before printing a final invoice.

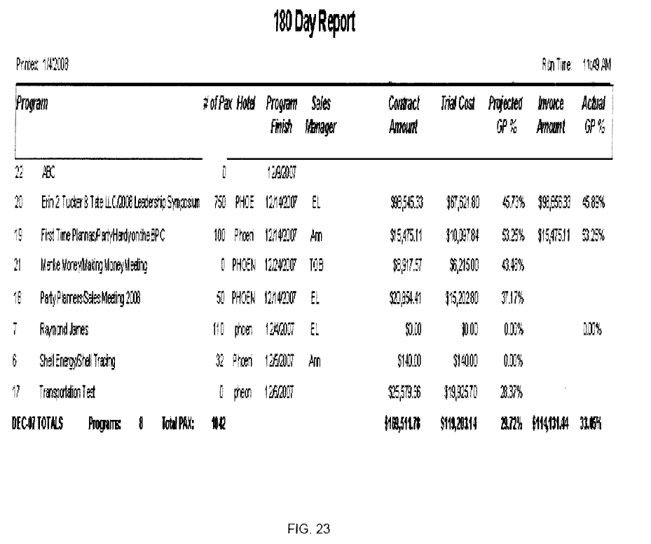

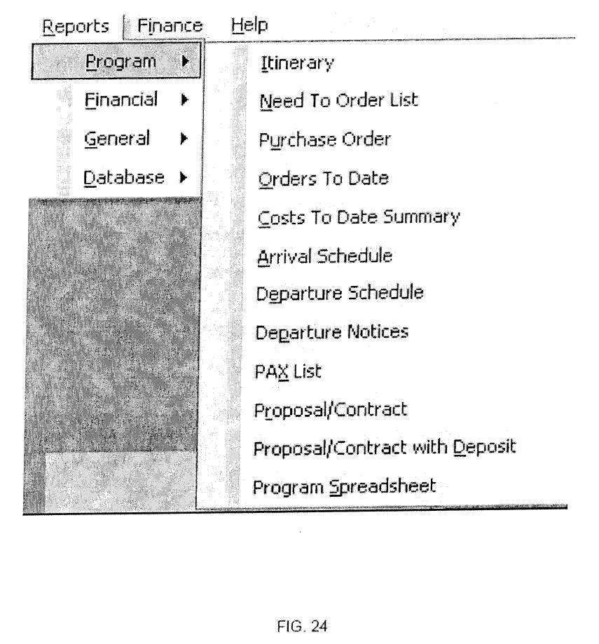

FIG. 23 is a window or webpage illustrating a 180 day financial report for revenue forecasting. The webpage instantly delivers the status of projected GP % versus the actual GP % of profit after invoicing. FIGS. 24-26 are windows or webpages illustrating a program menu for generating a plurality of management reports for revenue forecasting. The plurality of management reports includes a plurality of program reports, a plurality of financial reports, a plurality of general reports and the like.

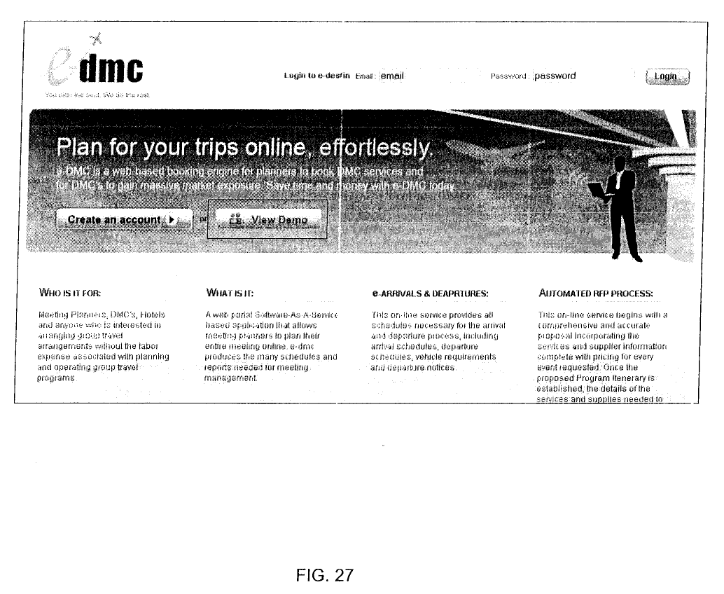

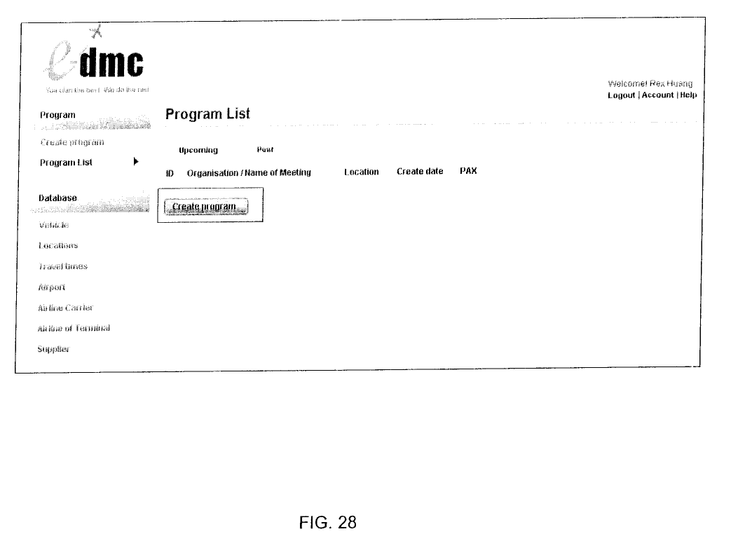

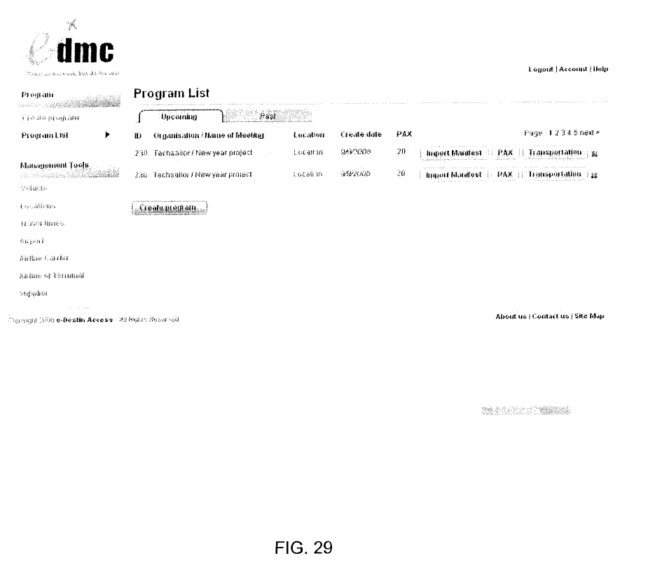

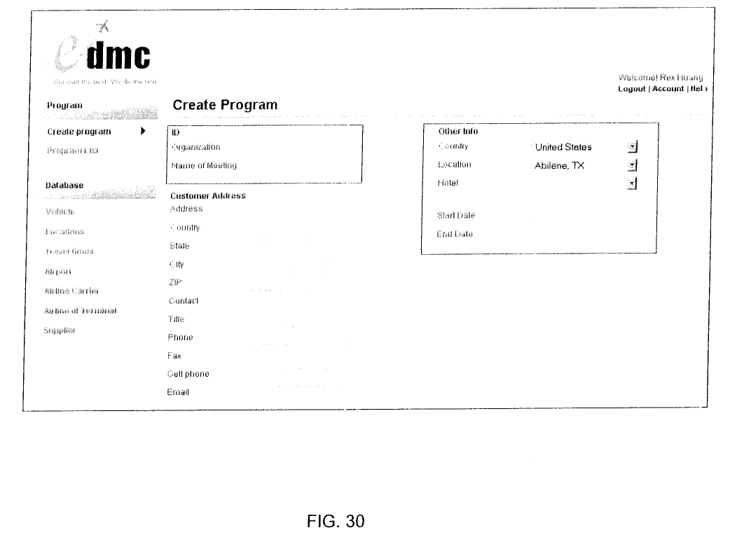

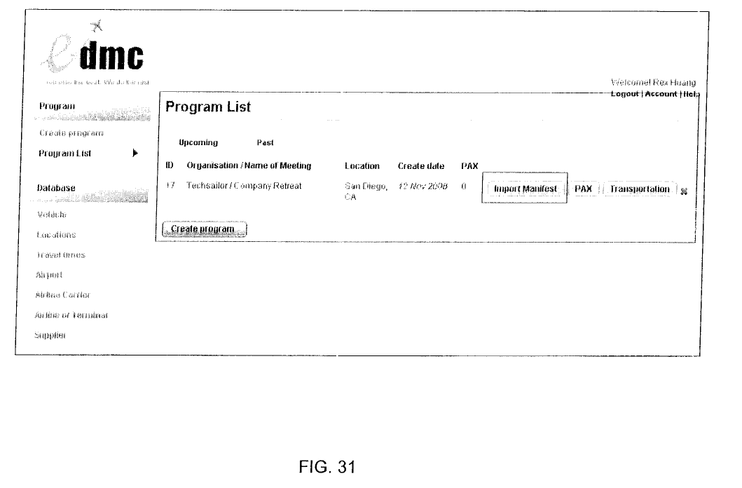

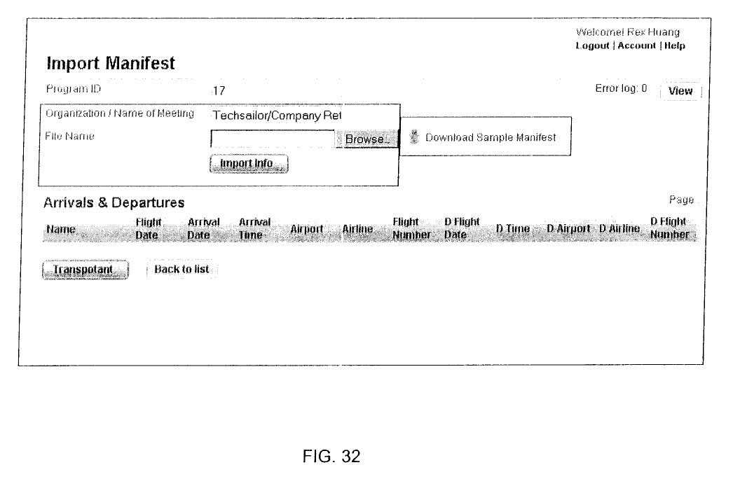

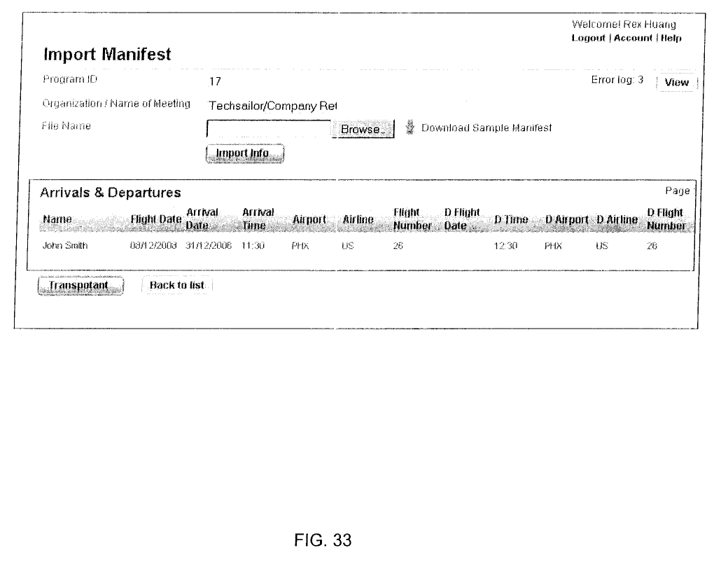

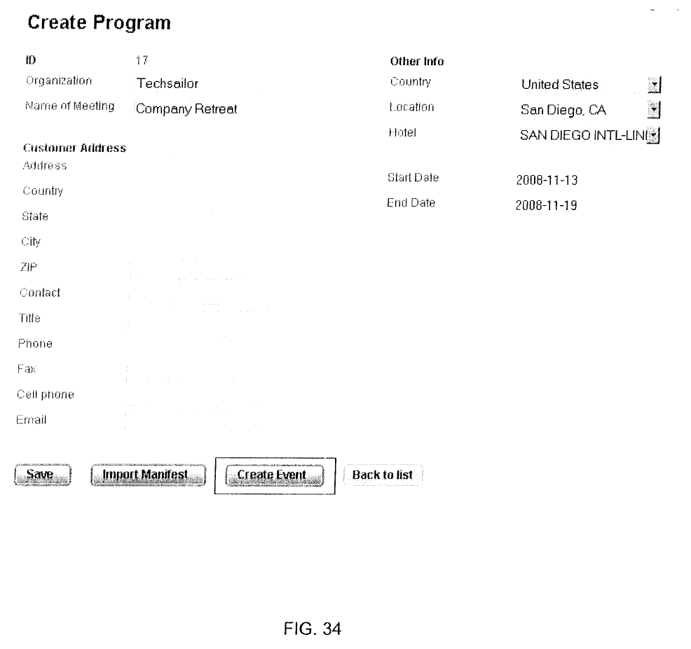

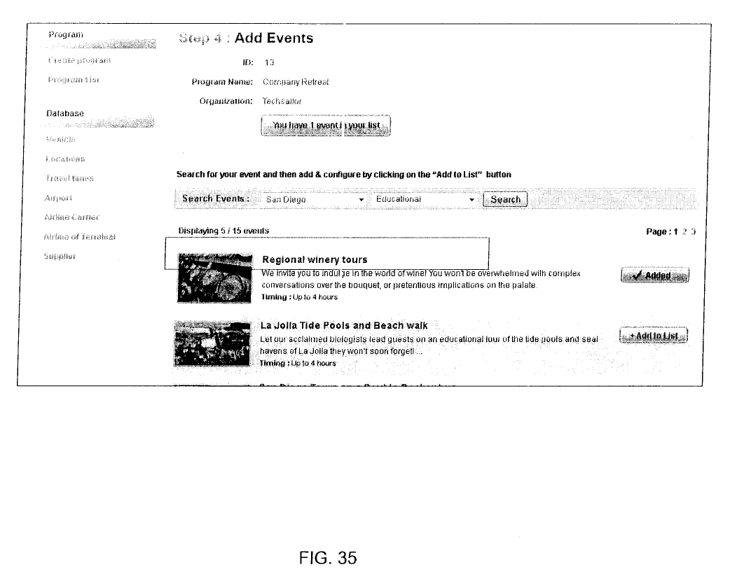

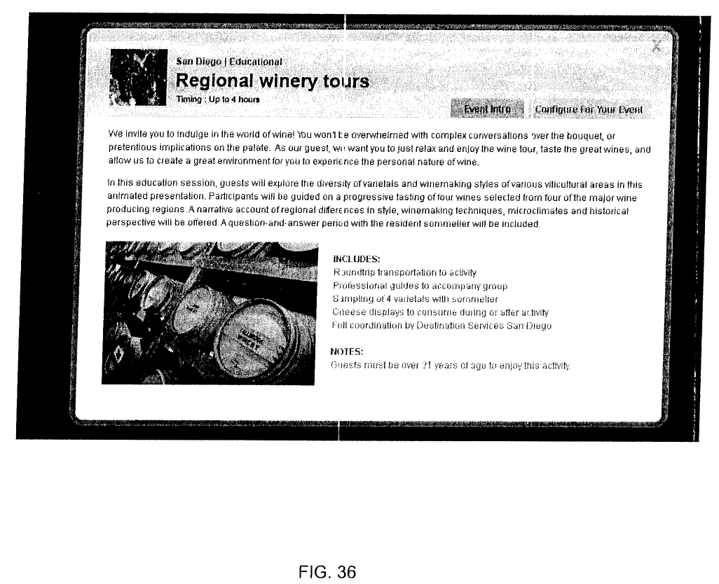

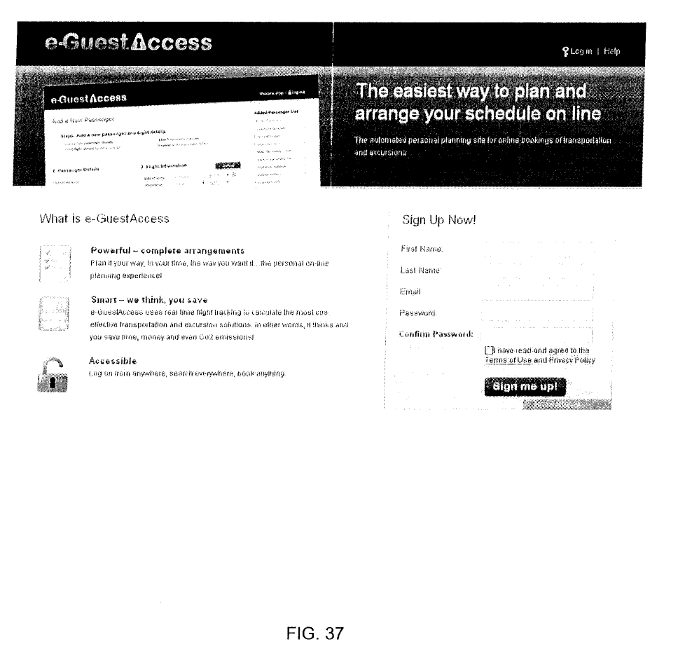

FIG. 27 through FIG. 37 are windows or webpage's of the present invention, illustrating an interface for planning and scheduling multiple resources on the internet, designed specifically for the FIT market segment using the same DESTIN database of information. Using the particular embodiments shown, users create an account and store or create various programs under detailed information. After creating a program, users can access the Import Manifest to retrieve and view a sample manifest, after which a user may access the program list again. In a particular embodiment of the program list, users may create detailed events by reference titles.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Although preferred embodiments of the present invention have been shown and described, various modifications and substitutions may be made thereto without departing from the spirit and scope of the invention. Accordingly, it is to be understood that the present invention has been described by way of illustration and not limitation.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. An enterprise resource planning (ERP) based total task integrated destination access and management system for utilizing a plurality of destination information and for automatically generating a plurality of destination management services capable of understanding destination management semantics, the system comprising:
a destination management service organizer, comprising a software operable to:
provide a graphical user interface (GUI) for receiving a plurality of informational components about a customer;
utilize the plurality of informational components to operate destination management services in a predetermined set of operational steps;
generate a file based on the information regarding the plurality of destination management services, the file containing a meta-model for the plurality of informational components; and
communicate the file containing the meta-model for the plurality of destination management services for access by the destination service organizer;
and a system database that includes a plurality of interactive tables linked together, the plurality of interactive tables storing the meta-model data about the plurality of informational components.

2. The system of claim 1, wherein the integrated destination access and management system is a Windows based software system.

3. The system of claim 1, wherein the system is utilized by business travel related entities, including destination management companies (DMC), incentive companies, hotels, meeting planners, and travel agents.

4. The system of claim 1, wherein the plurality of informational components include at least one event category, including destination of event, mode of travel, arrival, and arrival and departure details.

5. The system of claim 1, wherein the integrated destination access and management system is utilized for planning, scheduling, purchasing, operating and billing the at least one event.

6. The system of claim 1, wherein the plurality of interactive tables is updated automatically based on at least one change made to the plurality of informational components.

7. The system of claim 4, wherein the event category includes incentive travel programs, corporate events, international conferences, exhibitions, ground logistics and hospitality programs.

8. The system of claim 5, wherein the scheduling for the at least one event is based on a proprietary utilization of arrival and departure data from at least one flight status information database.

9. The system of claim 1, wherein the software further comprises an arrival and departure manifest including a plurality of vehicle spot times and departure times.

10. The system of claim 1, wherein the system generates a plurality of management reports for revenue forecasting, including a plurality of program reports, financial reports, general reports, and database reports, and prepares a final invoice.

11. A method for an enterprise resource planning (ERP) based total task integrated destination access and management system for utilizing a destination management service organizer, the method comprising:
preparing at least one proposal based on a plurality of informational components of at least one program event category from at least one customer;
turning the at least one proposal into a plurality of contracts;
providing a plurality of operational information;
automatically scheduling transportation needs;
generating a plurality of management reports for revenue forecasting; and
preparing at least one final invoice.

12. The method of claim 11, wherein the plurality of informational components include at least one event category, including destination of event, mode of travel, arrival and departure details.

13. The method of claim 11, wherein the system is utilized by business travel related entities including, destination management companies (DMC),incentive companies, hotels, meeting planners, and travel agents.

14. The method of claim 11 wherein the plurality of operational information comprises a plurality of program activities such as activity name, supplier name, location, and date.

15. The method of claim 13, wherein the meeting planners utilize an on-line application to send a request for proposal (RFP) based on a plurality of destination tariffs.

16. The method of claim 11, wherein the plurality of management reports comprise a plurality of program reports, financial reports, general reports, and database reports.

17. An enterprise resource planning (ERP) based total task integrated destination access and management system for utilizing a plurality of destination information and automatic generation of a plurality of destination management services capable of understanding destination management semantics, the system comprising:
a hospitality service organizer, comprising a software operable to:
create a system database based on a plurality of inputs from a guest for a plurality of services;
provide a plurality of concierge desk services for operating the guest arrival and/or departure schedule, including at least one vehicle automatically;
render a plurality of on-line services to at least one invitee of the guest linked to the system database;
arrange at least one vehicle schedule for picking up the at least one invitee;
and
generate at least one purchase order automatically for the plurality of concierge desk services and/or on-line services.

18. The system of claim 17, wherein the system is a Windows based software system.

19. The system of claim 17, wherein the system provides information to a plurality of hotel departments by way of a daily overview schedule.

20. The system of claim 17, wherein the plurality of inputs comprise the mode of travel, and arrival and departure details.

21. The system of claim 17 wherein the plurality of concierge desk services comprise arranging a plurality of vehicles, a plurality of hotel facilities, a plurality of entertainment venues, and a plurality of transportation links.

22. The system of claim 17, wherein the system is utilized for planning, scheduling, operating and billing at least one free independent travel (FIT) request.

23. The system of claim 17, wherein a plurality of interactive tables linked to the system database is updated automatically based on at least one change made to the plurality of inputs.

24. The system of claim 17, wherein the system comprises a plurality of management reports for revenue forecasting including a plurality of program reports, financial reports, general reports, and database reports.

25. A method for an enterprise resource planning (ERP) based total task integrated destination access and management system for utilizing a hospitality service organizer, the method comprising:
creating a system database based on a plurality of inputs from a guest for a plurality of concierge desk services;
customizing a plurality of vouchers for the plurality of concierge desk services;
tracking a plurality of guest itineraries;
monitoring a plurality of concierge desk services;
generating a plurality of management reports for revenue forecasting; and
preparing at least one final invoice.

26. The method of claim 25, wherein the system database comprises a plurality of interactive tables linked together, the plurality of interactive tables storing meta-model data about the plurality of inputs and services.

27. The method of claim 25, wherein the plurality of concierge desk services comprises arranging a plurality of vehicles, hotel facilities, entertainment venues, and transportation links.

28. The system of claim 25, wherein the system comprises a plurality of management reports for revenue forecasting including as a plurality of program reports, financial reports, general reports, and database reports.
